(19) United States
(12) Patent Application Publication
(10) Pub. No.: US 2013/0019644 A1
(43) Pub. Date: Jan. 24, 2013

(54) Horticulture bio-product

(71) Applicants: Robert T. Kiely, Fredericton (CA); Rodney J. Fry, Fredericton (CA)

(72) Inventors: Robert T. Kiely, Fredericton (CA); Rodney J. Fry, Fredericton (CA)

(21) Appl. No.: 13/507,628

(22) Filed: Jul. 16, 2012

Related U.S. Application Data
(60) Provisional application No. 61/457,960, filed on Jul. 19, 2011.

(51) Int. Cl. C05F 11/00; C05F 1/00; C05F 3/00

(52) U.S. Cl. 71/16; 71/23; 71/21; 71/25

(57) ABSTRACT

The bio-product includes a mixture of bark composts comprising up to 80% dried screened, aged-wood barks composts with up to 20% dehydrated and pasteurized agricultural residues from manure, potato and/or fish waste sources. The particle sizes, moisture content and pH of the bio-product is adjusted to satisfy three main markets; bio-fertilizers; turf top-dressings and peat moss substitute/amendment. The pH of the product is adjusted naturally by selecting and including therein bark composts from softwood and/or hardwood species.

This application claims the benefit of U.S. Provisional Application No. 61/457,960 filed Jul. 19, 2011.

### FIELD OF THE INVENTION

This invention pertains to horticulture bio-products based on bark composts and dehydrated and pasteurized agricultural, animal or fishery wastes.

### BACKGROUND OF THE INVENTION

The treatment and disposal of agricultural and animal wastes has become a complex problem. One of the challenges faced by the waste disposal industry is the increased resistance to sanitization of microbes contained in the waste materials rejected by animal and fish farms, and by food processing plants. The root cause of this increased resistance to sanitization is not very well known, but the effect is real and must be addressed upon disposal of these food and animal wastes. For examples, this increased resistance to sanitization of micro-organisms has raised concerns against the field disposal of manure using broadcast spreaders, direct landfill dumpings and even open air composting of organic wastes.

The U.S. Environment Protection Agency (EPA) has promulgated rules governing treatment of municipal wastes and the application or incorporation of treated wastes onto or into the ground. For example, where waste sludge is to be applied to land surfaces, or incorporated into soil under certain conditions of public access or consumption of livestock raised on the land, a process to significantly reduce pathogens (PSRP) is required. Currently approved processes to significantly reduce pathogens include aerobic and anaerobic digestion, air drying, composting and lime stabilization.

The EPA regulations further require a process to further reduce pathogens (PFRP) where crops for direct human consumption are to be grown. Currently approved processes to further reduce pathogens include composting at elevated temperatures, heat drying, heat treatment and thermophilic aerobic digestion.

In that regards, one publication related to sanitization of organic waste has been found in the prior art. This publication is identified as: US Patent Application 2004/0115090 published by Hans Anderson et al., on Jun. 17, 2004. This document discloses a method for sanitizing organic wastes without introducing exogenous heat or chemicals. The sanitization of organic waste is done by mixing the organic waste with nutrient-rich organic material, to form a porous matrix that can be maintained at a temperature and duration sufficient to reduce the amount of living organisms in the mixture to sanitary levels without introducing exogenous heat or chemicals. The process also involves the de-watering of the organic waste prior to the sanitization process, using various porous fibrous materials such as bark for example to absorb moisture.

Although the method of prior art deserve undeniable merits, it is believed that a more efficient method is required to fulfill industrial needs related to the sanitization of organic wastes.

### SUMMARY OF THE INVENTION

In the present invention, however, there is provided a bio-product that is obtained through mixing of organic waste materials with bark composts. The matrix obtained from the mixture is dehydrated, pasteurized and particle formed for use in the horticulture industry.

The bio-product according to the present invention is biologically stable and looks like peat moss. The bio-product can be used as a substitute for peat moss and/or as landscaping and horticulture amendment materials. The product can also be used as container mixes in greenhouse and tree-growing nurseries. The bio-product also has value in the dehydrated turf top-dressing and in the organic bio-fertilizer markets. This new bio-product includes the following agronomic and horticulture benefits: a) Improves beneficial soil microbes;

b) Enhances growing media structure, porosity and drainage;

c) Improves cation exchange capacity, and

d) Stabilizes or neutralizes soil pH balance.

Moreover, the bio-product complies with US Environment Regulations.

In one aspect of the present invention, the bio-product includes a mixture of dried-screened forestry bark composts comprising aged-wood bark composts with dehydrated and pasteurized agricultural residues from manure, potato and/or fish waste sources. More specifically, the bio-product according to the present invention includes up to 80% dried screened forestry bark composts from a mixture of aged wood barks and black-earth-like bark composts, with 20% dehydrated and pasteurized agricultural residues from manure, potato and/or fish waste sources.

The particle sizes, moisture content and pH of the bio-product is adjusted to satisfy three main markets; a) bio-fertilizers; b) turf top-dressing and c) peat moss substitute/amendment.

In another aspect of the present invention, the bio-product according to the present invention contains a large portion of bark composts, whereby the final acidic properties of the bio-product can be controlled by selecting and including therein bark composts from different wood species. For example, when the bio-product is used as peat moss substitute/amendment, the bark compost content thereof is selected from softwood compost, which naturally has an acidic pH. When the bio-product is used as a growing mix, the pH is raised to target levels by adding hardwood bark compost or a mixture of hardwood and softwood bark composts to achieve the properties requested by the end user.

This brief summary has been provided so that the nature of the invention may be understood quickly. A more complete understanding of the invention can be obtained by reference to the following detailed description of the preferred embodiment thereof in connection with the attached drawing.

### BRIEF DESCRIPTION OF THE DRAWING

A preferred process to manufacture the bio-product according to a preferred embodiment of the present invention is illustrated in the accompanying drawing, in which:

FIG. 1 is a schematic diagram illustrating in a general manner the process to produce the bio-product according to a preferred embodiment of the present invention.

### DETAILED DESCRIPTION OF THE PREFERRED EMBODIMENT

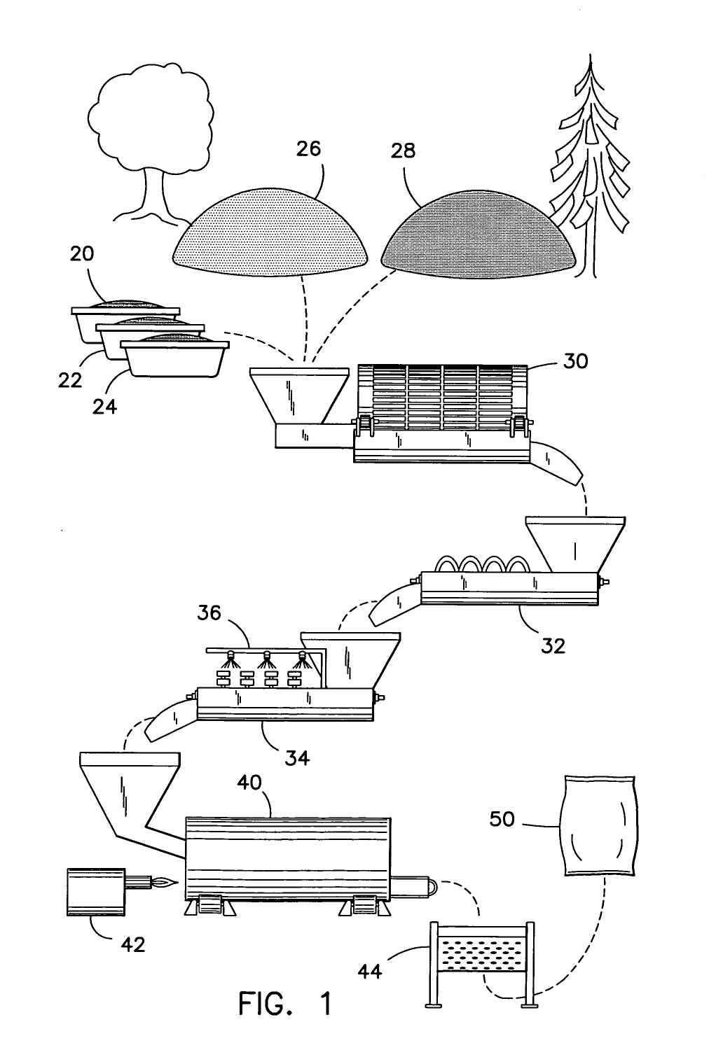

Referring to the drawing in FIG. 1, the preferred process for manufacturing the bio-product according to the preferred embodiment of the present invention will be described, such that the composition and structure of the bio-product will be better appreciated.

Briefly explained, the preferred process comprises the steps of mixing raw materials together, screening the mixed matrix, forming particles with the bio-product, heating the bio-product for dehydration and pasteurization and sizing and packaging the bio-product.

The agricultural waste portion of the bio-product is made from organic sludges and solid wastes that are selected from one, two or all three basic sources identified below:
a) agricultural food industry residues 20 including potato bio-solids, effluent filtrates and other food wastes;
b) livestock manures, 22 including poultry manure and other dairy farm and swine manures; and/or
c) fishery and fish processing residues 24 including salmon, herring, shrimp and lobster processing residues, rejects and other effluent filtrates.
   These sludges and solid wastes are referred to herein as the “nutrient waste portion” of the bio-product.

The bark compost portion of the bio-product according to the preferred embodiment of the present invention is made of aged-forestry softwood and hardwood residues including shavings, chips, sawdust, bark and black-earth-like bark compost harvested from historic sawmill landfills, and fully composted bark from pulp and paper mill and sawmill sites.

The bark compost material is dried, screened and stored in one of two piles 26, 28 according to its origin as hardwood or softwood species respectively.

The preferred composition of the bio-product is about 20% by volume nutrient waste and about 80% by volume bark compost.

The preferred process for manufacturing the bio-product according to the preferred embodiment includes the following steps and equipment.

Step 1, The mixing and screening apparatus 30 illustrated preferably has the form of a trommel-type rotary screener/mixer for example. This mixer 30 receives, mixes and homogenizes the nutrient waste portion 20, 22, 24 with the bark compost portion 26, 28 of the bio-product and provides a preliminary screening of oversize pieces and foreign materials.

Step 2, A ribbon mixer 32 further mixes and begins amalgamation of particles in the mixed matrix. The raw material entering this ribbon mixer 32 is wet, odorous, corrosive and of poor structure.

Step 3, The material is fed from the ribbon mixer 32 into a paddle mixer 34. An array of nozzles 36 is mounted above the paddle mixer 34 and sprays an organic polymer over the mixed matrix. The organic polymer is used to promote agglomeration of particles. It has been found that the combination of a ribbon mixer 32, organic polymer 36 and paddle mixer 34 produces uniform spherical particles in the mixed matrix.

Step 4, The raw material exiting the paddle mixer 34 is fed into a rotary drum dryer 40. The particles are dried, pasteurized and dehydrated at the same time in the rotary drum dryer 40. Furthermore, the spherical particles are made more uniform and are hardened during this cooking and tumbling action inside the dryer 40.

The ideal temperature reached by the bio-product in the rotary drum dryer 40 and the drying time to obtain pasteurization in compliance with PFRP Rules (EPA) are as follows:
Particle temperature to be maintained above 80° C. for a minimum of 10 minutes to a maximum of 30 minutes.
Dryer air temperature to be maintained at approximately 150° C. at the inlet and 80° C. at the outlet.

The heat required for pasteurizing the bio-product is preferably supplied to the rotary drum dryer 40 by a biomass burner 42. Sources of biomass for the burner 42 are the rejects from the different screens used in the preferred process.

The removal of fines, dust collection, odour control equipment, conveyors and other secondary equipment included in the preferred process are not illustrated or described herein because this is not the focus of the present invention. Moreover, these secondary equipment would be known to the person skilled in the field of the present invention, and therefore do not need to be described or illustrated.

Step 5, Particles exiting the rotary drum dryer 40 are fed to a vibrating screen 44 to removed fines and dust. Some of the screen rejects (fines) are returned back to the ribbon mixer 32 for further agglomeration with the raw material being processes at that stage. The screen mesh size in the vibrating screen 44 can be varied to suit the specification of the end users.

Step 6, The screened bio-product is then stored in bulk storage, or packaged in bags 50 for delivery to a end user. Bagging machinery has not been illustrated for being known in the field and for not being the focus of the present invention.

The entire bio-product dehydrating/pasteurizing process described herein and the finished bio-product according to the preferred embodiment of the present invention are designed to comply with the “Organic Certification Guidelines” as published by the United States Department of Agriculture—National Organic Program (USDA-NOP).

What is claimed is:

1. A bio-product containing 20% by volume of pasteurized nutrient waste and 80% bark compost.

2. The bio-product as claimed in claim 1, wherein said nutrient waste includes waste from an agricultural food production facility; livestock manures; and/or fishery and fish processing plant residues.

3. The bio-product as claimed in claim 2, wherein said nutrient waste from said agricultural food production facility contains potato bio-solids, and effluent filtrates from said agricultural food production facility.

4. The bio-product as claimed in claim 2, wherein said nutrient waste from said livestock manures contains poultry manure and other dairy farm and/or swine manures.

5. The bio-product as claimed in claim 2, wherein said nutrient waste from said fishery and fish processing plant residues contains salmon, herring, shrimp and/or lobster processing residues, rejects and other effluent filtrates from said fishery and fish processing plant.

6. The bio-product as claimed in claim 2, wherein said bark compost contains aged-forestry softwood and/or hardwood residues including shavings, chips, sawdust, bark and black-earth-like bark compost harvested from historic sawmill landfills, and fully composted bark from pulp and paper mill and sawmill sites.

7. The bio-product as claimed in claim 6, having a alkaline pH and wherein said bark compost contains bark compost from hardwood species and bark compost from softwood species.

8. The bio-product as claimed in claim 6 having an acidic pH and wherein said bark compost contains exclusively bark compost from softwood species.

9. The bio-product as claimed in claim 6, wherein said bark compost portion is made of bark compost from softwood species, bark composts from hardwood species, or a mixture of bark compost from hardwood species and bark composts from softwood species.

10. The bio-product as claimed in claim 9, wherein said bio-product contains spherical particles.

11. A bio-product containing 20% by volume of manure, potato and fish wastes, and 80% by volume of aged bark compost.

12. The bio-product as claimed in claim 11, wherein said bio-product contains spherical particles.

13. The bio-product as claimed in claim 11, having a alkaline pH and wherein said bark compost contains bark compost from hardwood species and bark compost from softwood species.

14. The bio-product as claimed in claim 11 having an acidic pH and wherein said bark compost contains exclusively bark compost from softwood species.

15. The bio-product as claimed in claim 11, wherein said bark compost portion is made of bark compost from softwood species, bark composts from hardwood species, or a mixture of bark compost from hardwood species and bark composts from softwood species.
